(19) United States
(12) Patent Application Publication
(10) Pub. No.: US 2010/0137523 A1
(43) Pub. Date: Jun. 3, 2010

(54) NANOPARTICLES AND FABRICATION THEREOF

(75) Inventors: Cesar E. Mendoza, Nottingham (GB); Amir Fahmi, Nottingham (GB); Nabil N. Z. Gindy, Nottingham (GB)

Correspondence Address: CHERNOFF, VILHAUER, MCCLUNG & STENZEL, LLP, 601 SW Second Avenue, Suite 1600, PORTLAND, OR, 97204-3157, US

(73) Assignee: THE UNIVERSITY OF NOTTINGHAM, Nottingham (GB)

(21) Appl. No.: 12/598,655

(22) PCT Filed: May 6, 2008
(86) PCT No.: PCT/GB2008/001547

§ 371 Date: Jan. 28, 2010

(30) Foreign Application Priority Data
May 4, 2007 (GB) 0708695.2

(51) Int. Cl. C08F 226/08; C08F 120/06; C08F 120/04; C08F 36/06; C08F 8/00

(52) U.S. Cl. 525/327.1; 525/329.7; 525/332.9; 525/371

(57) ABSTRACT

Creation of nanoparticle structures in two and three dimensions is advantageous in providing a number of functions such as in relation to catalytic, optical, electronic and magnetic propertied and other actions. Fabrication of such structures poses a considerable technical challenge. A block copolymer pair is used as a matrix to spatially organizes and aligns loaded inorganic materials in the form of nanoparticles. The inorganic precursors are selectively incorporated to a specific block of a di or tri block copolymer so that through solvent evaporation, reduction and mechanical working such as LAOS the orientation and positioning of the block copolymers nanoparticles are obtained into a desired structure.

The present invention relates to nanoparticles and fabrication thereof and more particularly with regard to forming ordered metallic nanoparticles into acceptable structures.

Research in nanotechnology has obtained macroscopically ordered nanostructures for miniaturized devices. However, fabrication of 2D and 3D-nanostructures is still a challenge that needs to be overcome before routine use of such technology is achieved.

Interest has focused upon directional properties obtained from functional hybrid materials, which can be potentially used for catalytic processes, photonic crystals and the next generation of electronic miniaturized devices.
The attractive characteristic of self-assembly has produced an increasing interest from both engineering and science disciplines. Among several types of systems that use the self-assembly phenomena, Block Copolymers stand out as a pathway to produce nanostructured materials. Reproducibility of its microstructure (with a variety of shapes), precision control in sizes, and spontaneous occurrence are the drivers of its potential to be used for high tech applications in manufacturing, biology, chemistry, electronics amongst others fields.

Hybrid materials based on block copolymer and metallic nanoparticles could be the key to developing new types of functional materials of varying properties very different from its original constituents. The properties of a hybrid material are not only dependent of the individual properties of the copolymer and metal but also on the specific orientation of the nanoparticles in the copolymeric matrix.

Block Copolymers, consist of two (or more) chemically different blocks of homopolymers connected by a covalent bond. Repulsive forces between the two blocks lead to their self-assembly in different patterns of periodical morphologies. By varying the volume fraction of one of the blocks, the material can adopt different shapes such as spheres, lamellae and cylinders, among others. The tendency of a BCP to microphase separate in these morphologies is described through N, the degree of polimerization, and χ_{AB} the Flory-Huggins interaction parameter between the two blocks.

Typically block copolymer morphologies exhibit local polydomain orientation, leading to a statistical isotropy with very low directional properties. However, in the presence of external fields, it is possible to induce orientation of these grains into a single crystal-like monodomain. It can be shown that BCPs could be aligned in shear flow and that Large Amplitude Oscillating Shear (LAOS) can also induce orientation of BCPs. Even though no general theory has been developed yet, it is known that the type of orientation (perpendicular, parallel, transverse) and quality of the alignment, are influenced by the specific selection of strain, frequency and temperature conditions.

Experiments on orientation of BCPs are typically performed in a parallel plates geometry. In this arrangement, a sinusoidal strain is applied in the lower plate, with oscillations having an amplitude γ₀, frequency ω and temperature T. The response signal of the material is measured with a torque transducer (upper plate) and plotted as the storage and loss moduli. In particular, frequency, strain and temperature are selected from characterization reograms obtained through dynamic thermo-mechanical analysis (DMTA). From a certain combination of these parameters, it is possible to create a set of conditions that in principle would lead to a macroscopic orientation. It will be appreciated that working can be achieved by other mechanisms such as extrusion, rolling, injection moulding, film blowing or fibre spinning in addition to working between plates.

The selective incorporation of nanoparticles in BCPs has opened up vast room for the design of this new class of multi-functional hybrid materials. Selectivity, particle size and spatial orientation are characteristics that play a key role when engineering these hybrids.

It would be desirable to provide a simple route to prepare a hybrid organic-inorganic material, based on self-assembled diblock copolymer and metallic nanoparticles selectively incorporated in a specific block. Such fabrication will utilise the special properties that can be exploited from these characteristics (selectivity and nanosize) of the block copolymer combination.

By aspects of the present invention an inorganic component is arranged to mimic the patterned morphology of a BCP (for example spheres, cylinders or lamellar structure); this is achieved by means of a selective incorporation of the inorganic component in one block of the block copolymers. Secondly, through external stimuli, induce arrangements of the metallic features so that the structures reach periodicities up to the millimetres scale. The resulting material provides an interesting set of potential applications that span from fibre-optics to biological scaffolds, all based on maximized anisotropic properties.

Further features of aspects to the present invention are described and outlined in the attached claims below.

Embodiments of aspects to the present invention will now be described by way of example only with reference to the accompanying drawings in which:—

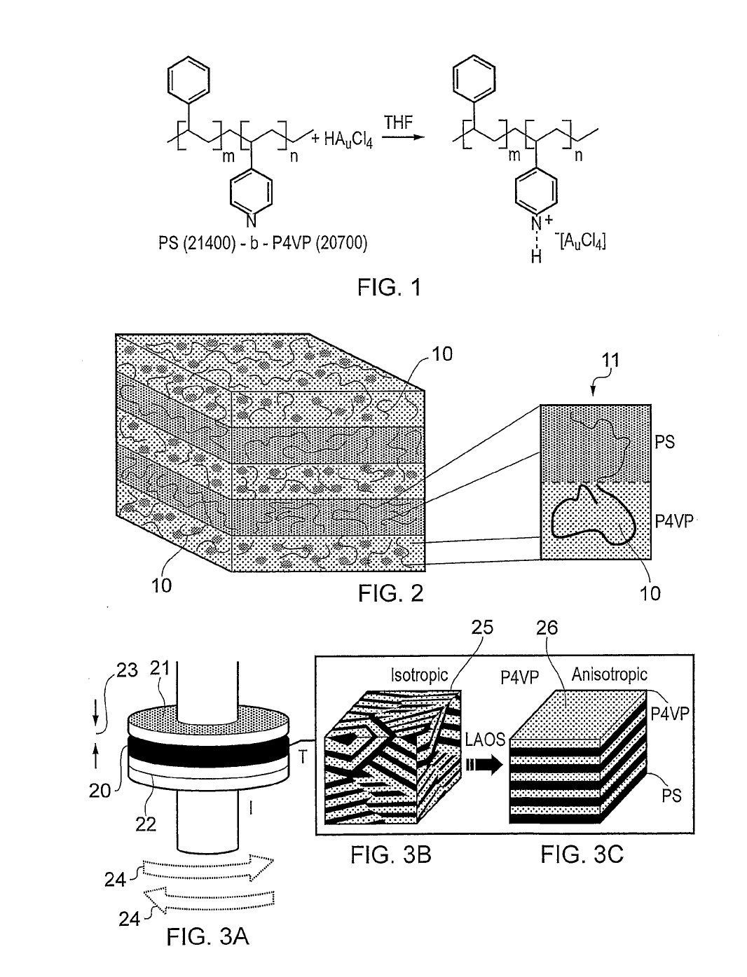

FIG. 1 is a chemical formula illustration of protonation and conglomeration in accordance with aspects of the present invention;

FIG. 2 illustrates the morphology of the hybrid material, in accordance to aspects of the present invention after evaporation of solvents;

FIG. 3 is a schematic illustration of an orientation process in accordance with aspects of the present invention;

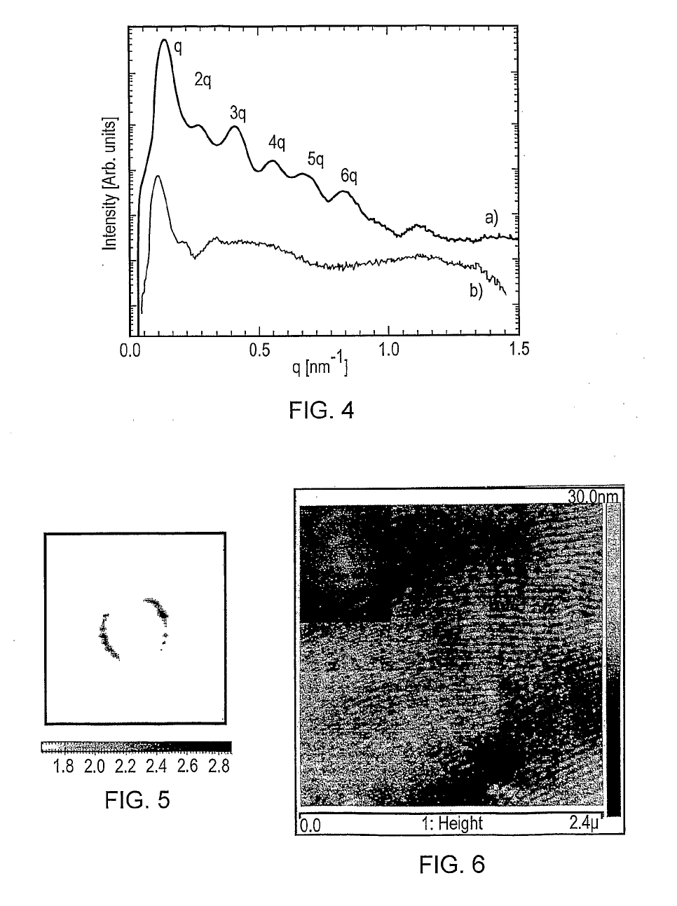

FIG. 4 is a SAXS diffraction pattern taken from a normal direction for a LAOS orientated and a non sheared sample;

FIG. 5 is a two dimensional SAXS pattern;

FIG. 6 is a micrograph image from a normal direction after application of LAOS;

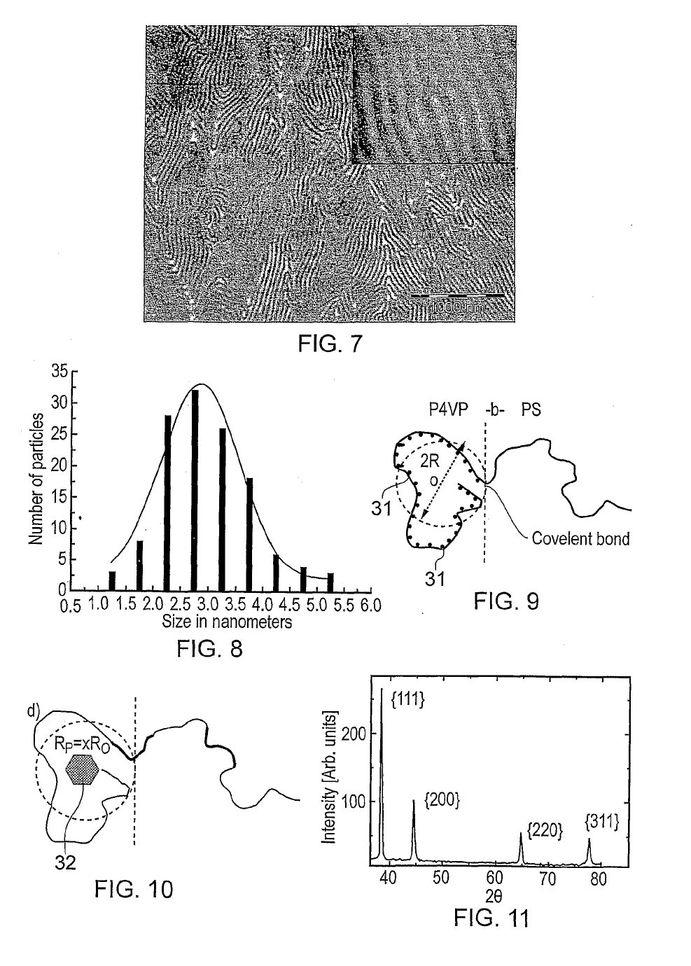

FIG. 7 is a transmission electron microscope image of an orientated sample from a normal direction;

FIG. 8 provides a histogram of nanoparticle diameters formed in accordance with aspects of the present invention;

FIG. 9 is a schematic illustration of pyridine blocks loaded with the inorganic precursor, as an example, gold precursor.

FIG. 10 is an illustration of elementary gold atoms aggregated after the in-situ reduction process;

FIG. 11 provides a WAXS diffraction pattern of gold for a sample of the material in accordance with aspects to the present invention; this test results is evidence that the nanoparticles are metallic and were effectively reduced from the inorganic precursor;

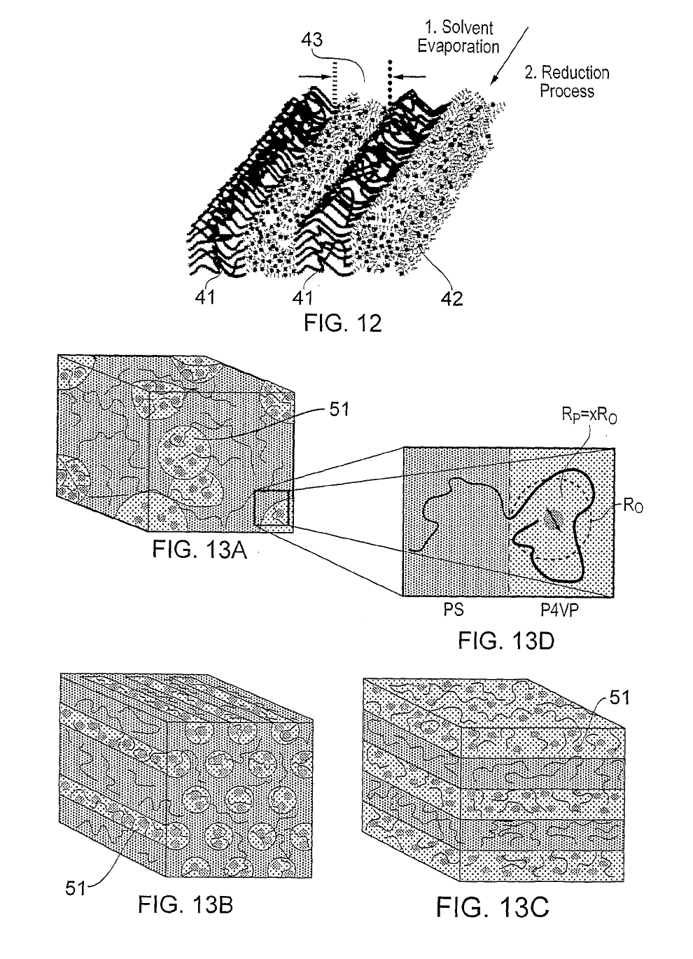

FIG. 12 provides a schematic perspective view though a cross-section of material; and

FIG. 13 provides a schematic illustration of different morphologies.

By aspects of the present invention there is provided a method to fabricate 3-D ordered arrays of inorganic elements embedded in an organic matrix. The inorganic elements are driven through self-assembly or auto-arrangement to mimic the patterned morphologies of block copolymer pairs or combinations (body centred cubic spheres, hexagonally packed cylinders or lamellar structure). The block copolymer combination (di-block or tri-block copolymers) acts as a matrix that organizes the inorganic material into the ordered shapes. The concept includes both the selective incorporation of an inorganic component in a specific part of the matrix, and its subsequent 3-dimensional ordering through external stimuli such as large amplitude oscillating shear (LAOS) or other mechanical working. The approach of aspects of the invention can provide different morphologies of the block copolymer such as

The problem with creating 2 or 3 dimensional nanoparticle structures related to appropriate positioning and alignment of the nanoparticles in order to provide the desired structures. By utilising the self-assembly of block copolymers and their ability to be orientated, particularly block copolymers when subject to appropriate mechanical work it is possible to create desirable anisotropic nano structures. The block copolymers are loaded with an inorganic material and in particular a metal (i.e., gold or another appropriate transition metal) in the form of an inorganic precursor, that is carried by the copolymer block structure into appropriate positioning such that by solvent evaporation and post reduction the inorganic or metal precursors aggregate to form elemental particles in appropriate positions in which to create the nanoparticle structures required and desired. As indicated above the structures may be nanorods (nano cylinders) or spherical or other structures utilised for functional purposes.

An embodiment of aspects to the present invention will now be described by way of example only. It will be appreciated other combinations of block copolymers and inorganic materials may be used. In the example solutions of chloroauric acid and the PS-b-P4VP block copolymer pair are prepared in stoichiometric amounts with respect to the pyridine groups. Protonation of the pyridine group and coordination of the counter ions to the P4VP backbone take place. Being carried out in solution, this process ensures the selective incorporation of the metal into the P4VP block. FIG. 1 provides a chemical formulae illustration of the protonation process.

FIG. 1 and FIG. 2 essentially provide schematics with regard to the chemical process for the incorporation of gold into the P4VP phase of a block copolymer pair. As illustrated in FIG. 1 the PS-block-P4VP combination is mixed in solution with chloroauric acid in stoichiometric proportions. Protonation of the pyridine group takes place and the subsequent coordination of the counter ion presented.

As illustrated in FIG. 2 after evaporation solvent a self or auto organisation takes place and the gold precursor is selectively incorporated into the P4VP block at certain locations. Metallic nanoparticles 10 are generated in situ through reduction of the gold precursor to elementary gold. In an inset zoom illustration 11 it will be seen that an individual metallic nanoparticle 10 is embedded within the P4VP block.

The reduction process of the gold precursor (oxidation state III) starts during a tablet pressing step (described later) and continues during an orientation process described later by the presence of heat under normal atmosphere in accordance with known processes but tailored to create desired alignment of the nanostructure. After solvent evaporation, the bulk material microphase separates to give a hybrid organic-inorganic material based on a BCP structure but, loaded with the gold precursor in the P4VP microdomains and depending upon the selected morphology. By changing the relative volume of each block with respect to each other (volume fraction), thus, the structure could be tailored to a lamellar, a cylindrical or a spherical structure among other morphologies. During reduction, elementary gold (oxidation state 0) atoms aggregate forming nanoparticles embedded in the P4VP microdomains, resulting in a composite organic-inorganic material as illustrated in FIG. 2.

Once formed the hybrid organic-inorganic material is then mechanically worked in order to provide further structural alignment. FIG. 3 provides a schematic illustration of such structural alignment. In such circumstances as illustrated in FIG. 3a a tablet 20 of material in a loaded block copolymer pairs is placed between two parallel plates 21, 22 in order that through rotation in the direction of arrowheads 24 the tablet material 20 can be worked in order to provide orientation as depicted in FIG. 3b. Mechanical working by rotation in the direction of arrowheads 24 will be achieved through conventional processes utilising motors and pressure sources. The working will be oscillating and at desired temperatures related to the glass transition temperatures of a first block copolymer and second a block copolymer of the pair.

As illustrated in FIG. 3b a schematically illustrated isotropic structure 25 can be converted by large amplitude oscillating shear (LAOS) processes to an anisotropic structure 26 in which a first block copolymer P4VP is loaded with metal nanoparticles, that is to say aggregates of elemental gold are provided in substantially separate layers from a second block copolymer PS. In such circumstances a material which is loaded with nanoparticles and is initially in an isotropic state when exposed to the mechanical working provided by large amplitude oscillating shear (LAOS) or otherwise for a specific period period of time results in an aligned polydomain structure allowing appropriate consideration with regard to forming microscopic structures for practical functions or uses.

As indicated the tablet 20 of material is exposed to LAOS. FIG. 3b shows schematically how the alignment of a polydomain structure looks like for a lamellar BCP pair. However, other shapes such as cylindrical or spherical could be achieved when conditions of temperature, frequency and strain are determined to perform the orientation processes necessary. Strain plots are used to determine necessary processes for the linear and non-linear viscoelastic regions. For lamellar, cylindrical and spherical morphologies, it is found that non-linearity starts from 1% deformation. Glass transition temperatures of both block copolymers were clearly identified at around 100° C. for the PS block and 140° C. for the P4VP, which is to be expected from previous analysis. Thus, the illustrated block copolymer pairs will allow convenient fabrication. Regarding oscillation frequencies, it is found a dominant elastic behaviour for the frequency range tested from 0.01 Hz-15 Hz.

In view of the above it is advantageous to run the orientation process at a temperature of about 130° C., at an oscillated frequency of 1 Hz and with 50% deformation. Such a combination of conditions was chosen based on experiences but other conditions may also be used dependent upon requirements. Successful orientation of the same di-BCP combination could be achieved with other associated conditions to meet desired structure

In the isotropic state 25, the BCP pair as already dictated, through microphase separation causes a local ordering of the selectively placed gold nanoparticles aggregation. This local ordering is extended into the bulk sample to the macroscale, under application of LAOS. Since the metal nanoparticles are embedded in the P4VP block, alignment of the BCP polydomain structure carries the alignment of the metal nanoparticles. Consequently, the nanoparticles are transported and aligned by that block alignment during the orientation process. The quality of the orientation process can be evaluated ex-situ, under small angle x-ray scattering (SAXS). Thus, a typical diffraction pattern for a lamellar structure is shown at FIG. 4 as line a). Up to six equally spaced intensity maxima are noticed in a position ratio 1:2:3 which is a characteristic of a highly oriented lamellar structure with q=0.135 nm⁻¹ and an average lamellar period of 47 nm. For contrast, consider the diffraction pattern for a sample not-exposed to LAOS as illustrated in FIG. 4 as the line b) in which only one intensity maxima can be identified indicating a clear polydomain structure.

FIG. 5 presents the 2D intensity plot corresponding to the SAXS diffraction pattern in FIG. 4 line a). Two higher intensities are observed in the ring, indicating the presence of domains with a preferential orientation. An AFM scan normal to the surface of a tablet of orientated material in accordance with aspects of the present invention is presented in FIG. 6 as a height image. It will be noted in the large area presented, a preferential orientation of the lamellar regions is observed, confirming orientation in accordance with aspects of the present invention. It will be understood by further adjustments of the orientation and other conditions it is possible to alter the quality of the orientation. With regard to alignment, an FFT of the image is presented as a qualitative measure of the quality of orientation as within FIG. 6. Continuous multiplicities spots are observed, showing one preferential alignment direction of the lamellar structure.

In such circumstances as illustrated above FIG. 4 provides through a diffraction pattern illustration with regard to an orientated (line a) and unorientated (line b) material in accordance with aspects to the present invention. The scattering vector is given by q=(4π/λ)Sin θ, 2θ being the scatter angle and λ cu=1.54 Å. In the corresponding two dimensional SAXS diffraction pattern illustrated in FIG. 5 the colour scale goes from 023.5×10⁴ SAXS intensity counts to provide the necessary grading. In the tapping mode AFM height image from a normal direction, after the application of LAOS as illustrated in FIG. 6 the preferential orientation can be observed over a micrometer range scale.

In order to evaluate the presence of nanoparticles, sizes and their arrangements FIG. 7 illustrates transmission electron microscope micrographs taken from a normal direction presented 2 mm from the centre of a tablet of material in accordance with respects to the present invention. It will be noted that the preferential alignment of the lamellar regions has occurred over large areas. Furthermore it is observed that the grain boundaries will start to merge with each other towards the main direction of alignment within the body of the material.

It will be appreciated previously it is typically necessary to provide staining in order to highlight the presence of a block copolymer combination, but in accordance with aspects of the present invention sufficient contrast is achieved such that it is not necessary to utilise any staining steps to the 70 nm thick cryo ultra-microtomed slices to provide images. Normally, to allow observation under TEM, staining with OSO₄ or gaseous iodine is needed to distinguish between the two block copolymer pair. Here it is clear the contrast between the PS rich regions and those loaded with gold P4VP regions is readily noticeable. The contrast arises from the metallic character of the gold nanoparticles and it is evidence that in fact, the nanoparticles are embedded selectively in only one of the blocks.

The image provided in FIG. 7 is from a transmission electron microscope where the sample is orientated and taken from a normal direction. 70 nm thick non stained slices are placed on a carbon coated copper grid to enable images to be taken.

FIG. 8 provides a histogram of nanoparticle diameters determined by taking measurements from the transmission electron microscope micrographs shown in FIG. 7. The histogram shows a mean diameter of 2.8 nm and a standard deviation of 0.7 nm. In such circumstances a schematic model for the formation of nanoparticles can be formulated. FIGS. 9 to 11 as will be described later provides schematic illustration with regard to this model for nanoparticles. Generally, pyridine blocks are loaded with gold precursor represented by dots 31. In such circumstances the dimensions of the representative block are described by Ro or end to end distance of the random coil. This selective presence of the gold precursor along the P4VP block is illustrated in FIG. 9. After an in-situ reduction process as illustrated in FIG. 10 elementary gold atoms aggregate to form a particle 32 which has dimensions which can be described as a function of Ro. FIG. 11 provides a WAXS diffraction pattern for a tablet of material in accordance with aspects of the present invention.

As regards to the nanoparticles, a histogram of particle sizes from the inset at FIG. 7 is presented in FIG. 8, showing a surprisingly homogeneous size distribution, with a mean particle size of 2.8 nm. This control might be explained given the limited mobility in the bulk state of individual elementary gold atoms, allowing a precise control of particle growth and sizes. Considering that the pyridine block constitutes a random coil of characteristic length Rₒ=2.16 nm, it encloses a spherical volume which maximum diameter of 4.3 nm.

Initially, one molecule gold precursor is coordinated to each pyridine group (FIG. 9). After a reduction process, neighbouring atoms of elementary gold within particular polymer coils can aggregate towards each other to form clusters leading to the crystalline metallic nanoparticles (FIG. 10). Since the BCP has a very low polydispersity, in principle this conveys a homogeneous size distribution of the particles within the P4VP rich region. Evidence is presented in FIG. 11 confirming that the process of reduction takes place in the P4VP rich regions. The reported WAXS diffraction pattern shows reflections corresponding to the scattering planes in a typical gold crystal, as this test was performed ex-situ and after the orientation process. Having a mean particle radius of R_{P}=1.4 nm, then from the ratio R_{P}/R₀=0.45 one can note that the particle size is half the radius of gyration. In comparison with theoretical determination, this ratio is high enough to perturb the BCP chains; however, lamellar morphology is preserved, in agreement with the expectation from simulated phase diagrams. Furthermore, a precise control on particle size is achieved and with a very low volume fraction of gold content of only 5%.

With regard to the precise components and conditions some of these are outlined below and given as the results of experimental data in order to provide examples of the samples as described above.

Materials—Preparation: Separate solutions of the diblock copolymer (PS (21400)-b-P4VP (20700) from Polymer Source Inc. with Mn/Mw=1.13, used as received.) and the chloroauric acid (Gold(III) chloride hydrate Purum ˜50% as Au from Fluka, used as received) are prepared by dissolving of each compound in analytical grade THF. The metal precursor is incorporated in stoichiometric amounts with relation to the number of pyridine groups in the block. Both solutions are mixed and stirred until a clean and transparent solution is obtained.

Tablet Pressing. After solvent evaporation a dried yellow powder is recovered. 60 mg were warm-compacted, between two Teflon disks, to form a 1 mm thick cylindrical tablet of 8 mm diameter. The process is carried out at a temperature of 160° C. and pressure of 10 Psi. During the first 30 min, the sample was allowed to fill the mould at the mentioned temperature exposed to normal atmosphere.

Rheology and orientation process. Tablets of the compound are loaded in a 8 mm parallel plate geometry of an Ares Rheometer (Rheometric Scientific) equipped with a 2KFRT transducer. All tests are performed under stress controlled-dynamic mode. Conditions of temperature (130° C.), strain (50%) and frequency (10 rad/s) are selected from the characterization process to run large amplitude oscillating shear flow process. Rheological characterization through DMTA is performed under linear viscoelastic regime, i.e., the shear stress is proportional to the amplitude of the applied strain. Under this regime, the applied strains are low enough (normally below 1%) so that the material structure is not perturbed by the deformation.

Atomic Force Microscopy. From the ultra microtomed samples, the remaining surface in bulk from the cutting process is scanned in a Dimension IV Nanoscope from Veeco, under tapping mode, using a silicon cantilever with a resonance frequency of 315 kHz.

Transmission Electron Microscopy. The tablets are previously embedded in epoxy resin. After curing, these are microtomed using an Ultramicrotome Leica EM UC6, equipped with a cryo chamber EMFC6. Diamond knifes for cryo temperatures (Diatome) were used for both the trimming (model DCTB) and cutting process (model Cryo)45°. The samples were trimmed and cut at −40° C.

From the ultra-microtoming process, 70 nm thick slices are obtained and placed over carbon coated copper grids (400 mesh Cu, from Agar). TEM is performed using a Tecnai T12 Biotwin microscope (FEI Company-UK Ltd) with an electron beam intensity of 100 keV.

It will be appreciated from above that aspects of the present invention provide a method to prepare 3D-periodic ordered metallic (which depending on the inorganic precursor used, could be conductive, Semi-conductive and Magnetic nanoparticles) nanostructures of hybrid organic-inorganic material, based on self-assembled diblock copolymer and metallic nanoparticles selectively incorporated in one block. Rheological conditions such as temperature, frequency and strain are comprehensively selected, in order to align the intrinsic polydomain structure of the hybrid material block copolymer pair. With these specific parameters, orientation is induced via large amplitude oscillating shear flow, using a parallel plates geometry. As a result, 3-dimensional periodical metallic nanostructures can be fabricated with alignment in dimensions up to the centimetres scale.

Small-angle X-ray scattering (SAXS) and wide-angle X-ray scattering (WAXS) is primarily used to inspect the resulting structures. Furthermore, atomic force microscopy (AFM) and transmission electron microscopy (TEM) were utilized to confirm the obtained morphologies.

This structures can be used in different application such as
to generate nanocapacitors
optical fibers
sensing effect
catalysis thought the high surface area of the metallic particles (Au-nanoparticles)
Memory chips (magnetic metallic elements)
Solar cells
Multicontracting circuits, nanowires

3D-periodic ordered metallic nanoparticles, take advantage of the self-assembly ability of the diblock copolymer. Thus, it is possible to dictate the order in a large micrometer scale through the application of large amplitude shear flow or other working. The method provides a narrow control on the metallic particle size, ranging between 2 and 4 nm. A structured organic-inorganic hybrid material can be developed, with the potential to be used for next generation photonic band gap materials and electronic devices on the nano scale.

Different morphologies of the block copolymer such as (lamellar, cylinders and spherical structure), can be achieved together with a variety of the most common transition metals.

FIG. 12 provides a schematic perspective view though a cross section of material in accordance with aspects of the present invention prior to orientation. In such circumstances it will be noted that the block copolymer (PS-P4VP) pair is mixed in solution with chloroauric acid. Self organisation takes place and the system undergoes microphase separation by which PS domains 41 separate from P4VP domains. The P4VP domains are loaded blocks 42 with gold nanoparticles in bulk. This configuration is achieved after a solvent evaporation and a reduction process as described above with regard to FIG. 1 and FIG. 2. It will be noted that for the example given, there is a lamellar thickness 43 after the orientation process in accordance to aspects of the present invention in the order of 20 to 24 nm.

FIG. 13 replicates some of the features described above with regard to FIG. 2. FIG. 13 in FIG. 13a illustrates some of the possible di-block copolymer morphologies with metal nanoparticles in a body centred cubic morphology whilst in FIG. 13b the arrangement is hexagonally packed cylinders and in FIG. 13c the lamellar structure similar to that depicted in FIG. 2 is provided. The metallic nanoparticles illustrated as dots 51 in each structure are embedded within the P4VP rich copolymer block. The nanoparticles are embedded within the P4VP respective block through microphase separation. In the expanded view illustrated by FIG. 13d an illustration of the individual metallic nanoparticle is provided. The particle has a size Rp which is a fraction x compared to the natural size of the polymer coil Ro illustrated by a broken line.

Aspects to the present invention achieve structures whether they be lamellar, spherical or otherwise by first loading a block copolymer with inorganic or metal particles which can then coagulate or otherwise combine to form basic nanoparticles which are loaded within a selected block of the block copolymer. In such circumstances when the known orientation and positioning aspects of those blocks in terms of covalent bonding occur the loaded particles similarly are transported and positioned as required into desired structures. The covalent bonding and other orientation aspects of the block copolymer pair LAOS action is facilitated by mechanical working in terms of applied shear, temperature and other features to achieve the desired structure. It will be understood that the particular working in terms of temperature, shear rate and other aspects may be adjusted as required as well as the particular block copolymer combination used and the relative loading of the copolymers with inorganic or metallic precursors and subsequent elements to form the nanoparticles.

Once the nanoparticle structures have been formed it will be appreciated that it may be possible to remove the copolymer by an appropriate process in order to leave the nanoparticle structures behind. Alternatively, the nanoparticle structures may be utilised in situ for certain effects.

Although described above with regard to a di-block copolymer it will be appreciated that aspects to the present invention may also be utilised with tri block copolymers. Such arrangement will allow a variety of morphologies and structures to be created. In such circumstances the general approach of aspects to the present invention in utilising appropriate protonation mechanisms for precipitating aggregates of inorganic precursors which are then located within one block copolymer which through appropriate mechanical working and auto orientation in view of covalent bonding between the block copolymer elements creates desirable structures such as lamellar, spherical or cylindrical. Although described above with regard to block copolymer PS-P4VP it will be understood that other block copolymer systems may be used. For example,
PS-b-P4VP Polystyrene-block-poly-4-vinylpyridine
PS-b-P2VP Polystyrene-block-poly-2-vinylpyridine
PS-b-PMMA Polystyrene-block-polymethylmetacrylate
PS-b-PAA Polystyrene-block-polyacrilic acid
PS-b-PB Polystyrene-block-polybutadiene
PS-b-PtBA Polystyrene-block-poly(tert-butylacrylate)
PS-b-PLA Polystyrene-block-polylactic acid
PS-b-PEO-b-PS Polystyrene-block-polyethylenoxide-block-Polystyrene (functional group being PEO)
PS-b-PLA-b-PS Polystyrene-block-polylactic acid-block-Polystyrene (functional group being PLA)

Aspects to the present invention create loading of a copolymer block with an inorganic precursor and then utilising the structural manipulation achievable by such block copolymer operation under temperatures and other mechanical working presentation of the inorganic elements within a desired structure is achieved. In such circumstances the particular loading of inorganic precursor and block copolymer system used will depend upon requirements in terms of structure to be created and other operational requirements.

Utilisation of mechanical working between two plates is described above. However, alternatively it will also be understood such mechanical working can be achieved by other processes. These other processes may include extrusion of the block copolymer system with loaded inorganic precursor in order to create the shear conditions similar to those described above between the opposed plates under rotation and possibly pressure. It will also be understood that a consolidation of the block copolymer system loaded with inorganic precursor/protonation means presented to rollers in order to provide mechanical working.

It will be understood that in particular desired structure morphography will be determined to a significant extend by the relative percentages of the block copolymer elements in the block copolymer combination.

For example, it may be that a fifty fifty proportioning between the block copolymer elements in a di-block copolymer will result in a lamellar structure. However, in accordance with aspects of the present invention it will also be understood that introduction of inorganic precursor loading as well as specific protonation species may shift the percentage distribution in the block copolymer system. This shift in the percentage distribution in turn will particularly shift the structure created by the combination of precursor loading, mechanical working and the block copolymer system shows in order to create desired structure consideration of all these factors will be made in attempting to provide the required structure.

As indicated above both di and tri block copolymer systems may be used. In particular tri block copolymer systems will typically allow a far greater number of structural morphologies and therefore potential desired structures.

The example of an embodiment of aspects to the present invention above is provided with regard to gold. The gold as indicated can be presented in a lamellar form or cylindrical form or spherical form depending upon requirements. However other inorganic structures may be created. Thus, if the objective is to create a catalyst it will be understood that precursors as described above for gold may be replaced with palladium or platinum and may be created into structures in accordance with aspects of the present invention. If a magnetic response is desirable then aggregates of nickel, cobalt or Fe₃O₄ may be distributed into the block copolymer system in order to generate structures as required. For electrical and semi conductor activities useful for solar cells it will be understood that Cd, Se, As, Ag, Co, Ni, Pd, Pt, Ti and O₂ may be presented as inorganic aggregates in accordance with aspects of the present invention in order to create desired structures for semi conductor or other electrical or optical activity. A further material which may be incorporated within the block copolymer structure is silver as silver has an anti microbial activity. In such circumstances a nanoparticle structure which has a relatively high surface area may be created and therefore the functional activity, whether that be catalytic, magnetic, electrical or a microbial may be presented upon that surface of the desired structure for enhanced capability.

As described above with regard to the example generally the inorganic precursor will be presented to the block copolymer system and combination initially in a liquid form. This liquid form will then be evaporated to a powder for appropriate mechanical working in accordance with aspects of the present invention or conversion from an isotropic to an anisotropic structure. Generally, the inorganic precursor will be presented in the form of an acid as described above or a salt such that appropriate inorganic precursors in the form of ions are presented within the liquid solution. These precursors in such circumstances as indicated above will be reduced to the elemental particle for appropriate aggregation in accordance with aspects to the present invention. The aggregation will locate the aggregate particle within the block copolymer structure to allow appropriate auto orientation into the desired structure with the mechanical working and temperature conditions for such action.

It will be appreciated that the inorganic precursor is incorporated selectively to the block of choice through use of an appropriate functional group. Such functional groups are generally formed by aromatic rings, insaturated groups or electron donors groups within the block copolymer structures. Examples of functional groups are as described above and include vinylpyridine, methylmetacrylate, acrilic acid, butadiene, (tert-butylacrylate), actic acid, and ethylenoxide groups.

It will be appreciate that as the block copolymer system is separated from the solvent (through the solvent evaporation process) and mechanically worked generally the separation of each block (self-assembly or auto-organisation process) will limit and control the positioning and size of the subsequent inorganic particle aggregations. In such circumstance again through appropriate choice of the block copolymer system such control of nanoparticle size may be achieved.

Although described principally above with regard to use of a single inorganic precursor in accordance with aspects to the present invention in order to provide nanoparticle structures it will also be understood that two or more inorganic precursors may be presented. These two or more inorganic precursors may be evenly distributed throughout the block copolymer system, in each block copolymer type or particular inorganic precursors loaded into particular block copolymer types. In such circumstances as a result of the auto orientation processes between the respective block copolymers in a block copolymer system the distribution of inorganic let us say metal or transition element can be controlled in each copolymer in order to create a desired nanoparticle structure across the block copolymers in the block copolymer system.

Modifications and alteration to aspects of the present invention will be appreciated by those skilled in the technology. Thus for example the protonation process in order to cause selective location of the precursor inorganic or metal may be adjusted for particular inorganic or metal precursors. Furthermore, protonation may be initiated utilising temperature or a chemical catalyst or otherwise.

1-34. (canceled)

35. A method of fabricating a macroscopically ordered hybrid nanostructure material, with a desired morphology, the method comprising choosing a block copolymer (diblock or triblock) combination comprising at least a first copolymer block and a second copolymer block loading one or two of the blocks of the block copolymer combination with an inorganic precursor, at least one of the copolymer blocks having a functional group for protonation or other chemical reaction of the inorganic precursor and subsequently, due to bonding between the copolymer blocks the material undergoes microphase separation and there after an in-situ reduction process, the inorganic precursor forming an aggregate of the elementary inorganic material as a nanoparticle and subjecting the block copolymer combination to mechanical working in order to induce further alignment of the block copolymer combination to define a spatial positional relationship between the copolymer blocks and the nanoparticles within a desired structure.

36. A method as claimed in claim 35 wherein the block copolymer combination is chosen from the group including PS-b-P4VP and PS-b-P4VP Polystyrene-block-poly-4-vinylpyridine and PS-b-P2VP Polystyrene-block-poly-2-vinylpyridine and PS-b-PMMA Polystyrene-block-polymethylmetacrylate and PS-b-PAA Polystyrene-block-polyacrilic acid and PS-b-PB Polystyrene-block-polybutadiene and PS-b-PtBA Polystyrene-block-poly(tert-butylacrylate) and PS-b-PLA Polystyrene-block-polylactic acid and PS-b-PEO-b-PS Polystyrene-block-polyethylenoxide-block-Polystyrene and PS-b-PLA-b-PS Polystyrene-block-polylactic acid-block-Polystyrene.

37. A method as claimed in claim 35 wherein the inorganic precursor is with regard to a transition metal.

38. A method as claimed in claim 35 wherein the inorganic precursor is in relation to one of Au or Pd and Pt and Co and Fe₃O₄ and CdSe and As, Co, and TiO₂ and As.

39. A method as claimed in claim 38 wherein the inorganic precursor is provided by an acid or salt.

40. A method as claimed in claim 35, wherein the loading of one (or more) blocks of the block copolymer is in stoichiometric proportions in relation to the functional groups of the chosen block copolymer with the inorganic precursor.

41. A method as claimed in claim 35, wherein the mechanical working includes the mechanical shear at an appropriate temperature depending on the block copolymer system under consideration.

42. A method as claimed in claim 41 wherein part of the mechanical working at least is provided by large amplitude oscillating shear (LAOS) for sequential shear of the block copolymer combination.

43. A method as claimed in claim 35 wherein the mechanical working is performed periodically with a frequency in the order of 0.1 Hz to 15 Hz.

44. A method as claimed in claim 35 wherein the alignment is performed at a temperature up to 140°

45. A method as claimed in claim 35 wherein the mechanical working provides greater than 1% elongation or contraction of the block copolymer pair.

46. A method as claimed in claim 35 wherein the auto orientation is performed substantially at 130 degrees C. with oscillatory stressing at 1 Hz with substantially the order of 50% deformation of the block copolymer pair.

47. A nanoparticle structure formed in accordance with a method as claimed in claim 35.

48. A nano structure comprising a block copolymer combination (di or triblock) having at least a first copolymer block and a second copolymer block associated by bonding, one or both of the blocks loaded with an inorganic precursor that are incorporated selectively by a protonation or another chemical process to form nanoparticles that result from a reduction process of the precursor, the nanoparticles are arranged by an auto orientation process which is due to the association between the first block copolymer and the second block copolymer to a desired structure by mechanical working.

49. A structure as claimed in claim 48 wherein a functional group is provided for protonation of the inorganic precursor and the functional groups one of a pyridine group and vinylpyridine and methylmetacrylate and acrilic acid and butadiene and (tert-butylacrylate) and actic acid and ethylenoxide.

50. A structure as claimed in claim 48, wherein the block copolymer combination comprises PS-6-P4VP.

51. A structure as claimed in claim 48 wherein the inorganic precursor is for one of Au and Pd and Pt and Co and Fe₃O₄ and CdSe and AsCd and TiO₂ and As.

52. A structure as claimed in claim 51 wherein the inorganic precursor is provided by loading within an acid or salt.

53. A structure as claimed in claim 49, wherein the inorganic precursor is provided in stoichiometric proportions with respect to the number of functional groups within the block copolymer in which the precursor is located.
